(19) United States
(12) Patent Application Publication
(10) Pub. No.: US 2011/0049826 A1
(43) Pub. Date: Mar. 3, 2011

(54) Skateboard Bubble Pipe

(76) Inventor: Jerry Madrid, Newport Beach, CA (US)

(21) Appl. No.: 12/553,964

(22) Filed: Sep. 3, 2009

(51) Int. Cl. B62M 1/00

(52) U.S. Cl. 280/87.042

(57) ABSTRACT

A novelty skateboard includes features common in skateboards and further includes an air passage and a cup for producing bubbles. The skateboard includes a deck, two trucks, and four wheels. The deck is made from cross laminated layers of a wood material. The air passage is formed lengthwise through one or more of the layers in the center of the deck and reaches from one end of the deck to an opposite end of the deck, and may be formed by a hollow rectangular insert laminated into the deck. One of the trucks includes a bypass reaching from a base plate of the truck to the cup. The bypass may pass through a hollow kingpin of the truck, or through the hanger of the truck.

### BACKGROUND OF THE INVENTION

The present invention relates to novelty skateboards and in particular to a skateboard further serving as a bubble pipe.

Skateboards are commonly used for recreational activities and are very popular among young people. Known skateboards provide a single use known for many decades and enjoyed world wide. However, many younger skateboarders are known to enjoy a variety of activities and novelty items. Therefore, a skateboard offering the novelty of a clever alternate use is desirable.

### BRIEF SUMMARY OF THE INVENTION

The present invention addresses the above and other needs by providing a novelty skateboard which includes features common in skateboards and further includes an air passage and a cup for producing bubbles. The skateboard includes a deck, two trucks, and four wheels. The deck is made from cross laminated layers of a wood material. The air passage is formed lengthwise through one or more of the layers in the center of the deck and reaches from one end of the deck to an opposite end of the deck, and may be formed by a hollow rectangular insert laminated into the deck. One of the trucks includes a bypass reaching from a base plate of the truck to the cup. The bypass may pass through a hollow kingpin of the truck, or through the hanger of the truck.

In accordance with one aspect of the invention, there is provided a skateboard and bubble pipe. The skateboard includes a deck, two trucks, and four wheels. The deck comprising cross laminated layers of wood material with a center layer having a longitudinally extending grain. A first truck is attached to a forward end of the deck and includes a first base plate, a first hanger, a first kingpin, and first bushings residing on the kingpin and sandwiching the hanger. A second truck is attached to a rear end of the deck and includes a second base plate, a second hanger, a hollow kingpin, and second bushings residing on the kingpin and sandwiching the hanger. The wheels attached to the trucks. A hollow insert is laminated into the deck and has a rectangular exterior cross-section and an interior passage, and reaches through the deck from a forward end of the deck to a rear end of the deck. An intermediate opening in the passage connects the passage to a bottom surface of the deck adjacent to the second truck and a bypass passage overlaps the intermediate opening and passes through the second base plate and the hollow kingpin. A cup resides on an exposed head of the hollow kingpin and in opens into the bypass passage.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 is a top perspective view of a prior art skateboard.

FIG. 2 is a bottom perspective view of the prior art skateboard.

FIG. 3A is a top view of a skateboard according to the present invention.

FIG. 3B is a side view of the skateboard according to the present invention.

FIG. 3C is a front view of the skateboard according to the present invention.

FIG. 3D is a rear view of the skateboard according to the present invention.

FIG. 4A is a front view of a truck according to the present invention.

FIG. 4B is a side view of the truck according to the present invention.

FIG. 4C is a rear view of the truck according to the present invention.

FIG. 5 is a cross-sectional view of the truck according to the present invention taken along line 5-5 of FIG. 4A.

FIG. 5a is a cross-sectional view of a second truck according to the present invention taken along line 5-5 of FIG. 4A.

FIG. 6 is a cross-sectional view of the skateboard according to the present invention taken along line 6-6 of FIG. 3A.

FIG. 7 is a cross-sectional view of the skateboard deck according to the present invention taken along line 7-7 of FIG. 6.

FIG. 8 is a cross-sectional view of the skateboard deck according to the present invention taken along line 8-8 of FIG. 7.

FIG. 9 is a side view of the skateboard deck according to the present invention.

FIG. 10 is a cross-sectional view of the skateboard deck according to the present invention taken along line 10-10 of FIG. 9.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

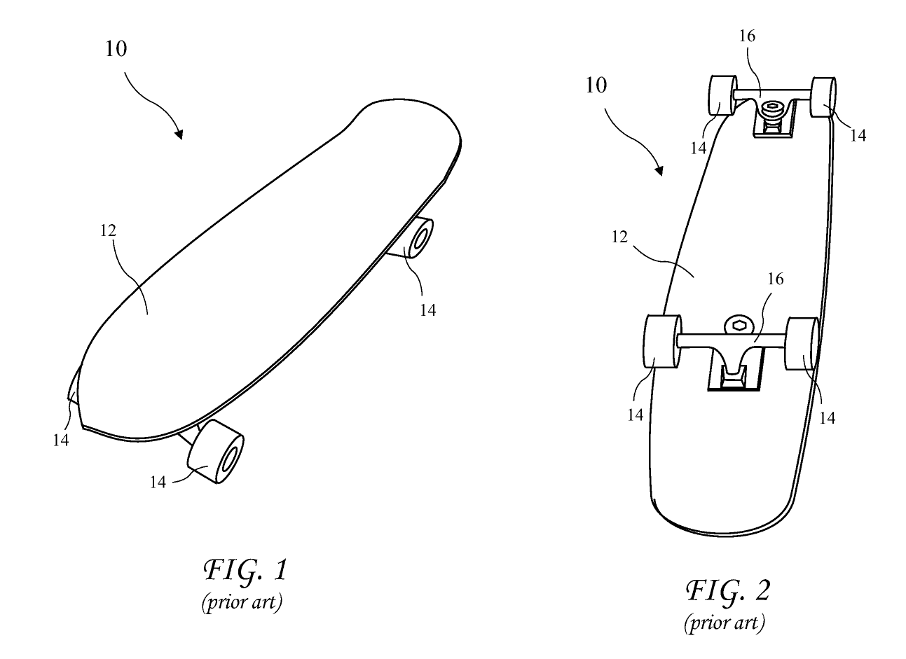

A top perspective view of a prior art skateboard 10 is shown in FIG. 1 and a bottom perspective view of the prior art skateboard 10 is shown in FIG. 2. The skateboard 10 includes a deck 12, trucks 16 mounted to the forward and rear ends of the deck, and wheels 14 mounted to the trucks 16.

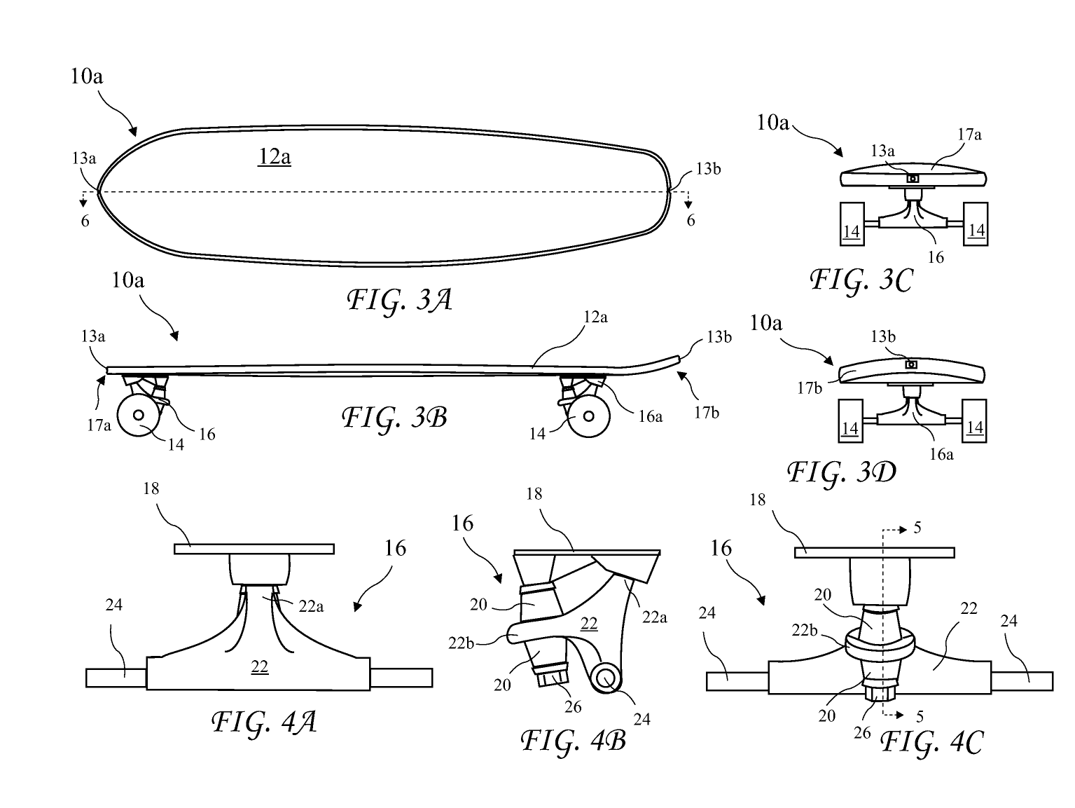

A top view of a skateboard 10a according to the present invention is shown in FIG. 3A, a side view of the skateboard 10a is shown in FIG. 3B, a forward (or front) view of the skateboard 10a is shown in FIG. 3C, and a rear view of the skateboard 10a is shown in FIG. 3D. The skateboard 10a includes a passage 13 (see FIGS. 7 and 8) having a forward opening 13a at a forward end 17a of the deck 12 and a rear opening 13b at a rear end 17b of the deck 12.

A front view of the truck 16 according to the present invention is shown in FIG. 4A, a side view of the truck 16 is shown in FIG. 4B, and a rear view of the truck 16 is shown in FIG. 4C. The truck 16 includes a base plate 18 which attaches to the deck 12, a hanger 22 pivotally engaging the base plate 18 at a pivot end 22a, axles 24 reaching laterally from the hanger 22 for mounting the wheels 14, and a kingpin 26 holding the hanger 22 in place. Two bushings 20 reside on the kingpin 26 and sandwich a ring portion 22b of the hanger 22. The kingpin 26 may be tightened or loosened (or harder or softer bushings may be selected) to adjust the turning responsiveness of the skateboard.

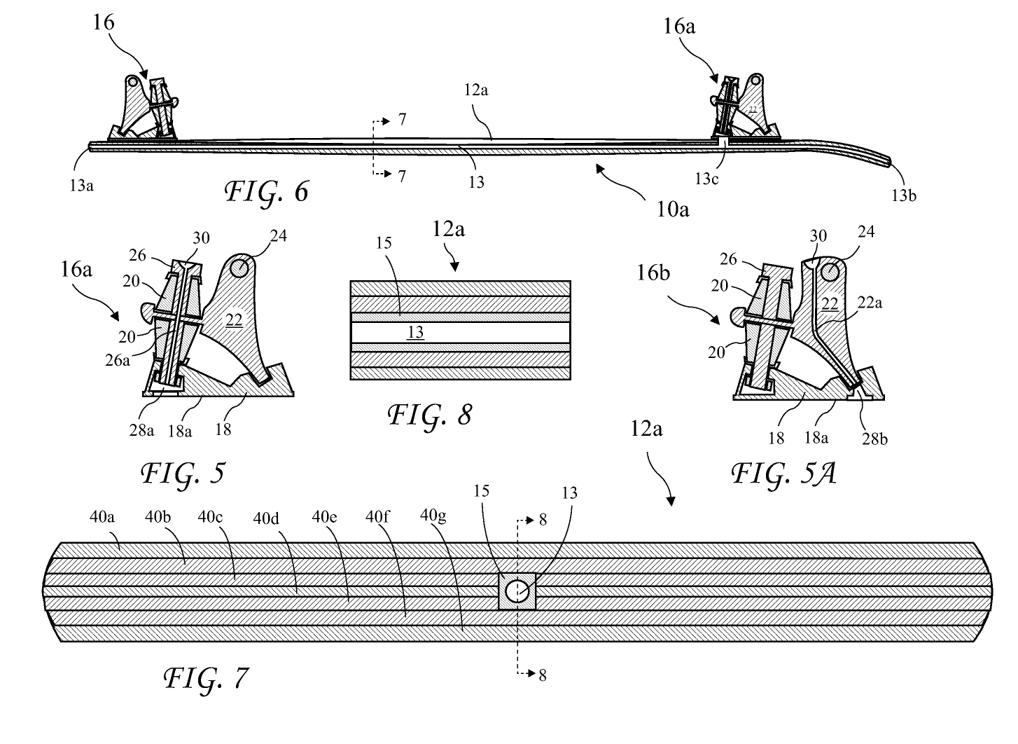

A cross-sectional view of the truck 16a according to the present invention taken along line 5-5 of FIG. 4C is shown in FIG. 5 and a cross-sectional view of the skateboard 10a taken along line 6-6 of FIG. 3A is shown in FIG. 6. The truck 16a includes a hollow kingpin 26 with a passage 26a and a first opening 28a through the base plate 18, to provide a bypass passage through the truck 16a from a mounting surface 18a of the base plate 18 to a cup 30. The opening 28a overlaps an intermediate opening 13c in the deck 12 to place the cup 30 in fluid communication with the passage 13.

A cross-sectional view of a second truck 16b according to the present invention taken along line 5-5 of FIG. 4C is shown in FIG. 5A. The truck 16b includes a hanger 22 with a bypass passage 22a placing the cup 30 in fluid communication with the passage 13.

A cross-sectional view of the skateboard deck 17a taken along line 7-7 of FIG. 6 is shown in FIG. 7 and a cross-sectional view of the skateboard deck 12a taken along line 8-8 of FIG. 7 is shown in FIG. 8. The deck 12a comprises cross and straight laminated layers 40a-40g of wood material with a center layer having a longitudinally extending grain. The passage 13 is preferably a passage in a hollow insert 15 laminated into the deck 12a. The hollow insert 15 conforms to a void area in the laminated layers of wood material forming the deck 12 and for example, may have a rectangular outer cross-section, another uniform cross-section, or an irregular cross-section. The insert 15 is preferably made of high-density polypropylene material or a similar material.

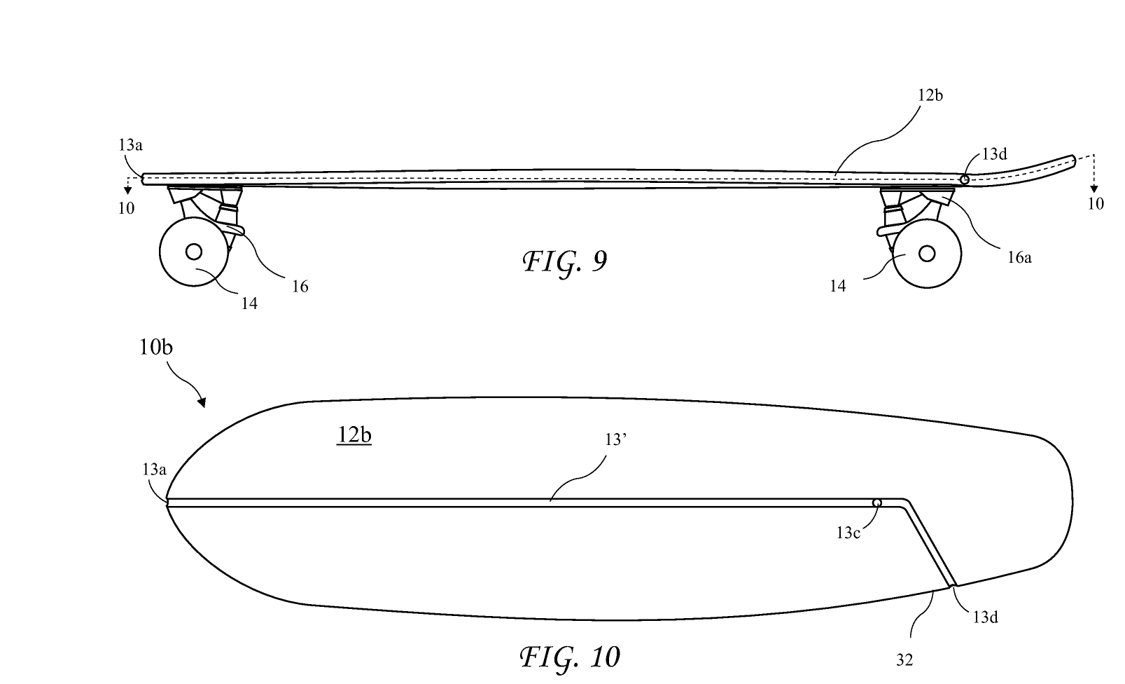

A side view of a second skateboard deck 12b according to the present invention is shown in FIG. 9 and a cross-sectional view of the skateboard deck 12b taken along line 10-10 of FIG. 9 is shown in FIG. 10. The deck 12b includes a curved passage 13′ which reaches the truck 16a or 16b, but then turns to a side edge 32 of the deck 12b. The deck 12b is otherwise similar to the deck 12a.

While the skateboard described above includes a deck, two trucks, and four wheels, skateboards are known which replace one of the two wheel trucks with a single wheel. All skateboard including the passage and bypass through a truck or other wheel mounting including such variations are intended to come within the scope of the present invention.

While the invention herein disclosed has been described by means of specific embodiments and applications thereof, numerous modifications and variations could be made thereto by those skilled in the art without departing from the scope of the invention set forth in the claims.

I claim:

1. A skateboard comprising:
a deck;
a first truck attached to a forward end of the deck, the forward truck comprising a first base plate, a first hanger, a first kingpin, and first bushings residing on the kingpin and sandwiching the hanger;
a second truck attached to a rear end of the deck, the rear truck comprising a second base plate, a second hanger, a second kingpin, and second bushings residing on the kingpin and sandwiching the hanger;
wheels attached to the trucks;
a passage through the deck having an open first end and an open second end opposite the first end;
an intermediate opening in the passage connecting the passage to a bottom surface of the deck;
a bypass passage through one of the trucks connecting a mounting surface of the base plate to an exposed surface of the truck; and
a cup on an exposed surface of the truck and opening into the bypass passage.

2. The skateboard of claim 1, wherein the passage through the deck reaches from a forward end of the deck to a rear end of the deck.

3. The skateboard of claim 1, wherein the deck comprises cross and straight laminated layers of wood material with a center layer having a longitudinally residing grain and the passage is vertically centered on the center layer.

4. The skateboard of claim 3, wherein the passage comprises a hollow insert laminated into the deck.

5. The skateboard of claim 4, wherein the hollow insert has an outside cross-section conforming to an opening through the laminated layers of wood material forming the deck.

6. The skateboard of claim 3, wherein the passage is a straight passage reaching from a forward end of the deck to a rear end of the deck.

7. The skateboard of claim 3, wherein the passage is a curved passage reaching from an end of the deck, under one of the trucks, and to a side surface of the deck.

8. The skateboard of claim 1, wherein the kingpin is hollow providing the bypass passage.

9. The skateboard of claim 1, wherein the bypass passage is through the hanger.

10. A skateboard comprising:
a deck;
a first truck attached to a forward end of the deck, the forward truck comprising a first base plate, a first hanger, a first kingpin, and first bushings residing on the kingpin and sandwiching the hanger;
a second truck attached to a rear end of the deck, the rear truck comprising a second base plate, a second hanger, a second kingpin, and second bushings residing on the kingpin and sandwiching the hanger;
wheels attached to the trucks;
a passage through the deck having an open first end and an open second end opposite the first end;
an intermediate opening in the passage connecting the passage to a bottom surface of the deck;
a bypass passage through one of the kingpins connecting a mounting surface of the base plate to an exposed surface of the truck; and
a cup on an exposed head of the kingpin, the cup opening into the bypass passage.

11. A skateboard comprising:
a deck comprising cross laminated layers of wood material with a center layer having a longitudinally extending grain;
a first truck attached to a forward end of the deck, the forward truck comprising a first base plate, a first hanger, a first kingpin, and first bushings residing on the kingpin and sandwiching the hanger;
a second truck attached to a rear end of the deck, the rear truck comprising a second base plate, a second hanger, a hollow kingpin, and second bushings residing on the kingpin and sandwiching the hanger;
wheels attached to the trucks;
a hollow insert laminated into the deck and having a rectangular exterior cross-section and an interior passage, the hollow insert reaching through the deck from a forward end of the deck to a rear end of the deck;
an intermediate opening in the passage connecting the passage to a bottom surface of the deck adjacent to the second truck;
a bypass passage overlapping the intermediate opening, through the second base plate, and the hollow kingpin; and
a cup on an exposed head of the hollow kingpin and in opening into the bypass passage.
